(19) United States
(12) Patent Application Publication
(10) Pub. No.: US 2017/0305196 A1
(43) Pub. Date: Oct. 26, 2017

(54) Crown For Aircraft Tire

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Emmanuel JOULIN, Clermont-Ferrand Cedex 9 (FR)

(21) Appl. No.: 15/517,833

(22) PCT Filed: Sep. 18, 2015
(86) PCT No.: PCT/EP2015/071396

§ 371 Date: Apr. 7, 2017

(30) Foreign Application Priority Data
Oct. 8, 2014 (FR) 1459638

(51) Int. Cl. B60C 9/20; B60C 9/28; B60C 11/00

(52) U.S. Cl. CPC B60C 9/2009; B60C 9/28; B60C 2011/0033; B60C 2009/283; B60C 2009/209; B60C 2009/2077; B60C 2009/2051; B60C 2009/2022; B60C 2009/2016; B60C 2200/02; B60C 2009/208

(57) ABSTRACT

Tire for an aeroplane and, in particular, the crown thereof which comprises a tread (1), a textile crown reinforcement (2) and a textile carcass reinforcement (4). In order to optimize the number of landings, in the equatorial plane, the thickness (E1) of the tread is at least equal to 1.1 times the thickness of the working reinforcement and the thickness (E5) of the carcass is at least equal to 1.5 times the thickness (E3) of the working reinforcement, the reinforcing elements of the working layers (31, 32, 33) having a tenacity at least equal to 90 cN/tex.

The present invention relates to a tire for an aeroplane and, in particular, to the crown of an aeroplane tire.

A tire comprises a crown comprising a tread that is intended to come into contact with the ground via a tread surface, two beads that are intended to come into contact with a rim, and two sidewalls that connect the crown to the beads. A radial tire, as generally used for an aeroplane, more particularly comprises a radial carcass reinforcement and a crown reinforcement, as described, for example, in the document EP 1 381 525.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively.

In the following text, the expressions “radially on the inside of” and “radially on the outside of” mean “closer to the axis of rotation of the tire, in the radial direction, than” and “further away from the axis of rotation of the tire, in the radial direction, than”, respectively. The expressions “axially on the inside of” and “axially on the outside of” mean “closer to the equatorial plane, in the axial direction, than” and “further away from the equatorial plane, in the axial direction, than”, respectively. A “radial distance” is a distance with respect to the axis of rotation of the tire and an “axial distance” is a distance with respect to the equatorial plane of the tire. A “radial thickness” is measured in the radial direction and an “axial width” is measured in the axial direction.

The radial carcass reinforcement is the tire reinforcing structure that connects the two beads of the tire. The radial carcass reinforcement of an aeroplane tire generally comprises at least one carcass reinforcement layer referred to as the carcass layer. Each carcass layer consists of reinforcing elements which are coated in a polymeric material, are parallel to one another and form an angle of between 80° and 100° with the circumferential direction. Each carcass layer is unitary, i.e. it comprises only one reinforcing element in its thickness.

The crown reinforcement is the reinforcing structure of the tire radially on the inside of the tread and usually radially on the outside of the radial carcass reinforcement. The crown reinforcement of an aeroplane tire generally comprises at least one crown reinforcement layer referred to as the crown layer. Each crown layer consists of reinforcing elements which are coated in a polymeric material, are parallel to one another and form an angle of between +20° and −20° with the circumferential direction. Each crown layer is unitary, i.e. it comprises only one reinforcing element in its thickness.

Among the crown layers, a distinction is made between the working layers that constitute the working reinforcement and are usually made up of textile reinforcing elements, and the protective layers that constitute the protective reinforcement, are made up of metal or textile reinforcing elements and are arranged radially on the outside of the working reinforcement. The working layers govern the mechanical behaviour of the crown. The protective layers essentially protect the working layers from attack likely to spread through the tread radially towards the inside of the tire. A crown layer, in particular a working layer, is often an axially wide layer, i.e. one that has an axial width, for example, at least equal to two-thirds of the maximum axial width of the tire. The maximum axial width of the tire is measured at the sidewalls, the tire being mounted on its rim and lightly inflated, i.e. inflated to a pressure equal to 10% of the nominal pressure as recommended, for example, by the Tire and Rim Association or TRA.

The tire can also comprise a hoop reinforcement radially on the inside or radially on the outside of the crown reinforcement or interposed between two crown layers. The hoop reinforcement of an aeroplane tire generally comprises at least one hoop reinforcement layer referred to as the hooping layer. Each hooping layer consists of reinforcing elements which are coated in a polymeric material, are parallel to one another and form an angle of between +10° and −10° with the circumferential direction. A hooping layer is usually an axially narrow working layer, i.e. one that has an axial width substantially less than the axial width of a crown layer and, for example, at most equal to 80% of the maximum axial width of the tire. The axial width of a layer of reinforcers is understood to be the axial distance between the axially outermost reinforcing elements of said layer, whether or not the distance between each reinforcing element is constant in the axial direction.

The reinforcing elements of the carcass, working and hooping layers, for aeroplane tires, are usually cords made up of spun textile filaments, preferably made of aliphatic polyamides or aromatic polyamides. The reinforcing elements of the protective layers may be either cords made up of metal threads or cords made up of spun textile filaments.

As far as the textile reinforcing elements are concerned, the mechanical properties under tension (modulus, elongation and force at break, tenacity) of the textile reinforcing elements are measured after prior conditioning. “Prior conditioning” means the storage of the textile reinforcing elements for at least 24 hours, prior to measurement, in a standard atmosphere in accordance with European Standard DIN EN 20139 (temperature of 20+/−2° C.; relative humidity of 65+/−2%). The measurements are taken in the known way using a ZWICK GmbH & Co (Germany) tensile test machine of type 1435 or type 1445. The textile reinforcing elements are subjected to tension over an initial length of 400 mm at a nominal rate of 200 mm/min. All the results are means of 10 measurements.

Aeroplane tires often exhibit non-uniform wear to the tread, known as irregular wear, resulting from the stresses that occur during the various life stages of the tire: take-off, taxiing and landing. Differential wear to the tread between a middle part and the two lateral parts of the tread, axially on the outside of the middle part, has more particularly been observed. Usually, it is desirable for the wear to the middle part to be greater and to control the life of the tire. In some cases, the abovementioned differential wear worsens the wear to the lateral parts of the tread, this becoming predominant with respect to the wear to the middle part, resulting in economically disadvantageous premature removal of the tire.

A person skilled in the art is familiar with the fact that the wear to the tread of a tire depends on several factors associated with the use and design of the tire. Wear depends in particular on the geometric shape of the contact patch via which the tread of the tire makes contact with the ground and on the distribution of mechanical stresses in this contact patch. These two parameters depend on the inflated meridian profile of the tread surface. The inflated meridian profile of the tread surface is the cross section through the tread surface, on a meridian plane, for an unladen tire inflated to its nominal pressure.

In order to increase the life of the tire with regard to the differential wear to the middle part of the tread, a person skilled the art has sought to optimize the geometric shape of the inflated meridian profile of the tread surface.

The document EP 1 163 120 discloses a crown reinforcement of an aeroplane tire, wherein attempts have been made to limit the radial deformations when the tire is being inflated to its nominal pressure. This makes it possible to limit the radial deformations of the inflated meridian profile of the tread surface. The radial deformations of the crown reinforcement when the tire is being inflated to its nominal pressure are successfully limited by increasing the circumferential tensile stiffnesses of the crown layers, this being obtained by replacing the crown layer reinforcing elements, which are usually made of aliphatic polyamides, with reinforcing elements made of aromatic polyamides. Because the moduli of elasticity of reinforcing elements made of aromatic polyamides are higher than those of reinforcing elements made of aliphatic polyamides, the elongations of the former, for a given tensile loading, are smaller than those of the latter.

The document EP 1 381 525 cited above proposes one approach which is to alter the geometric shape of the inflated meridian profile of the tread surface by altering the tensile stiffnesses of the crown and/or carcass layers. That document proposes the use of hybrid reinforcing elements, that is to say reinforcing elements made both of aliphatic polyamides and of aromatic polyamides, rather than the usual reinforcing elements made of aliphatic polyamides. These hybrid reinforcing elements have moduli of elasticity that are higher than those of the reinforcing elements made of aliphatic polyamides, and therefore have lower elongations, for a given tensile loading. The hybrid reinforcing elements are used in the crown layers to increase the circumferential tensile stiffnesses and/or in the carcass layers to increase the tensile stiffnesses in the meridian plane.

The document EP 1 477 333 proposes another approach which is to alter the geometric shape of the inflated meridian profile of the tread surface by axially altering the overall circumferential tensile stiffness of the crown reinforcement in such a way that the ratio between the overall circumferential tensile stiffnesses of the axially outermost parts of the crown reinforcement and of the middle part of the crown reinforcement lies within a defined range. The overall circumferential tensile stiffness of the crown reinforcement is a result of the combination of the circumferential tensile stiffnesses of the crown layers. The overall circumferential tensile stiffness of the crown reinforcement varies in the axial direction according to changes in the number of superposed crown layers. The proposed solution is based on an axial distribution of the overall circumferential tensile stiffnesses between the middle part and the axially outermost parts of the crown reinforcement, referred to as the shoulders, the middle part being stiffer than the axially outermost parts of the crown reinforcement. The reinforcing elements used in the crown or carcass layers are made of aliphatic polyamides, aromatic polyamides or are hybrid.

The document WO 2010000747 describes an aeroplane tire, the nominal pressure of which is higher than 9 bar and the deflection of which under nominal load is greater than 30%, comprising a tread having a tread surface, a crown reinforcement, comprising at least one crown layer, a carcass reinforcement comprising at least one carcass layer, said tread surface, crown reinforcement and carcass reinforcement respectively being geometrically defined by initial meridian profiles. According to the invention, the initial meridian profile of the crown reinforcement is locally concave over a middle part having an axial width at least equal to 0.25 times the axial width of the crown reinforcement. The technical solution described in the document WO 2010000747 allows an increase in the wear life of an aeroplane tire by limiting the differential wear to the tread between a middle part and the lateral parts axially on the outside of this middle part.

The inventors have set themselves the objective of improving the wear to an aeroplane tire that is intended to bear heavy loads and is inflated to pressures greater than 15 bar.

This objective has been achieved by a tire for an aeroplane, comprising:
a tread having a centre thickness that is measured in the equatorial plane, passing through the middle of the tread and perpendicular to the axis of rotation of the tire, between the radially outermost point of the tread and the radially outermost point of a crown reinforcement radially on the inside of the tread,
the crown reinforcement comprising at least one working reinforcement,
the working reinforcement comprising at least one working layer that has an axial width LT, measured over the working layer having the greatest axial width, at least equal to ⅔ of the maximum axial width of the tire, and having a centre thickness in the equatorial plane, said thickness being measured between the radially outermost point of the radially outermost working layer and the radially innermost point of the radially innermost working layer,
the working layers comprising textile reinforcing elements,
a carcass reinforcement, radially on the inside of the working reinforcement, comprising at least one carcass layer and having a centre thickness in the equatorial plane, said thickness being measured between the radially outermost point of the radially outermost carcass layer and the radially innermost point of the radially innermost carcass layer,
the carcass layers comprising textile reinforcing elements,
a reinforcement that is formed by the working reinforcement and the carcass reinforcement and has a centre thickness in the equatorial plane, said thickness being measured between the radially outermost point of the radially outermost working layer and the radially innermost point of the radially innermost carcass layer,
the centre thickness of the tread is at least equal to 1.1 times the centre thickness of the reinforcement formed by the working reinforcement and the carcass reinforcement,
the centre thickness of the tread is at least equal to 1.5 times the centre thickness of the working reinforcement,
the reinforcing elements of the working layers have a tenacity at least equal to 90 cN/tex.

The working reinforcement of a tire is generally made up of a plurality of radially superposed working layers that have, in a meridian plane of the tire, axial widths that are generally different from one layer to another, in order to stagger the axial ends of said working layers. The working reinforcement generally comprises at least one working layer referred to as wide, i.e. with an axial width at least equal to two-thirds of the maximum axial width of the tire. The maximum axial width of the tire is measured at the sidewalls, with the tire mounted on its rim and lightly inflated, i.e. inflated to a pressure equal to 10% of the recommended nominal pressure. Usually, but not exclusively, the radially internal working layer, i.e. the one that is radially innermost, is the widest working layer. By extension, this width of the widest working layer is known as the width of the working reinforcement.

The axial width of a working layer is the axial distance between the end points of said working layer. It is usually measured on a meridian section of the tire, obtained by cutting the tire on two meridian planes. By way of example, a meridian section of tire has a thickness in the circumferential direction of around 60 mm at the tread. The measurement is taken with the distance between the two beads being kept identical to that of the tire mounted on its rim and lightly inflated.

On this same meridian section, the centre thickness of the tread is measured in the equatorial plane as the distance between the radially outermost point of the tread and the radially outermost point of the radially outermost layer of the crown reinforcement. This radially outermost layer of reinforcers can be either the protective layer or, in the absence of a protective layer, the radially outermost working layer. The radially outermost point of the radially outermost layer of the crown reinforcement is obtained by tracing a spline passing through the radially outermost points of each reinforcer of said layer. This spline intersects the equatorial plane through the radially outermost point of said layer at the equatorial plane.

Also on this same meridian section, the centre thickness of the reinforcement, comprising the working and carcass reinforcements, is measured in the equatorial plane. The centre thickness of the reinforcement is the distance between the radially outermost point of the radially outermost working layer and the radially innermost point of the radially innermost carcass layer. The measurement points belonging to the equatorial plane are obtained by the intersection of said plane and of splines passing through the radially outermost points of the reinforcing elements of the radially outermost working layer and through the radially innermost points of the reinforcing elements of the radially innermost carcass layer, respectively.

Similarly, on this meridian section, the centre thickness of the working reinforcement is measured in the equatorial plane. The centre thickness of the working reinforcement is the distance between the radially outermost point of the radially outermost working layer and the radially innermost point of the radially innermost working layer. The measurement points belonging to the equatorial plane are obtained by the intersection of said plane and of splines passing through the radially outermost points of the reinforcing elements of the radially outermost working layer and through the radially innermost points of the reinforcing elements of the radially innermost working layer, respectively.

The tenacity of a reinforcing element is equal to its force at break divided by its count. It is expressed in cN/tex or centinewtons per tex. The count, or linear density, is determined on at least three cord samples, each corresponding to a length of at least 5 m, by weighing this length; the count is given in tex (weight in grams of 1000 m of product—as a reminder: 0.111 tex is equal to 1 denier).

The reinforcing elements of the working layers of aeroplane tires are usually aliphatic polyamides with a tenacity less than 80 cN/tex. The use of materials with a higher tenacity, that is to say at least equal to 90 cN/tex, makes it possible to reduce the number of working layers for a superior endurance performance. The weight savings brought about thereby are of particular interest to the aeronautical industry for long haul aeroplanes in order to increase the number of passengers or the cargo tonnage or in order to decrease the consumption of fuel. On the other hand, for regional use, controlling the maintenance costs by increasing the number of landings carried out per tire, that is to say improving the wear life performance, is a crucial parameter. Although the use of reinforcing elements having a tenacity at least equal to 90 cN/tex allows a weight saving, it also, surprisingly, through the modification of the associated operating points, allows a decrease in deformations and thus a significant drop in the temperature of the hottest points of the crown. This represents an additional advantage in terms of endurance, part of which can be converted into wear life by significantly increasing the centre thickness of the tread. The endurance potential that it is thus possible to convert into landing wear is expressed by the ratio of the thickness of the reinforcement and the thickness of the tread and by the ratio of the thickness of the working reinforcement and the thickness of the tread. Through calculation and measurements, at the centre, in the equatorial plane, the thickness of the tread optimizing wear is at least equal to 1.1 times the thickness of the reinforcement and is at least equal to 1.5 times the thickness of the working reinforcement.

For these same tires, the crown endurance means that the centre thickness of the tread is at most equal to 2.4 times the centre thickness of the reinforcement formed by the working reinforcement and the carcass reinforcement, and that the centre thickness of the tread is at most equal to 3.5 times the centre thickness of the working reinforcement. This is because a tread that is too thick entails a higher use temperature, resulting in a drop in the stiffness of the crown rubbers, it being possible for this to result in the cracking thereof during use of the tire.

It is particularly advantageous, for lowering the temperature at the crown and improving the endurance of the tire, all the more so since the possible number of landings has been increased by the increase in the thickness of the tread, for the reinforcing elements of the carcass reinforcement to be made of materials with a tenacity at least equal to 90 cN/tex and for the centre thickness of the tread in the equatorial plane to be at least equal to 4.2 times the centre thickness of the carcass reinforcement. This makes it possible to convert part of the additional endurance potential provided by the use of reinforcing elements of the carcass reinforcement having a tenacity at least equal to 90 cN/tex into an improvement in landing wear.

The centre thickness of the carcass reinforcement is measured on the meridian section, in the equatorial plane. The centre thickness of the carcass reinforcement is the distance between the radially outermost point of the radially outermost carcass layer and the radially innermost point of the radially innermost carcass layer. The measurement points belonging to the equatorial plane are obtained by the intersection of said plane and of splines passing through the radially outermost points of the reinforcing elements of the radially outermost carcass layer and through the radially innermost points of the reinforcing elements of the radially innermost carcass layer, respectively.

It is important to associate, with an increase in landing wear expressed by the centre thickness of the tread, an increase in the rolling wear by increasing the thickness of rubber at the shoulder, that is to say in the axially outermost parts of the tread, in order to avoid an imbalance between the rolling wear potential and the landing wear potential, which imbalance would cause an irregular wear pattern as mentioned above and notably in the prior art.

In order to evaluate the shoulder thicknesses, a straight line is defined in the meridian section, said straight line being known as a measuring line for the shoulder thicknesses that passes through the centre of the tire, at the intersection of the equatorial plane and the axis of rotation, and through the point of the widest working layer, said point being positioned at an axial distance from the equatorial plane equal to 0.9 times the axial half-width LT/2 of said layer. Regardless of its function, i.e. working or protection, the radially outermost crown layer at the shoulder is the layer intersecting the measuring line and radially outermost. The term “intersecting the measuring line” means that said layer has, in the meridian section, reinforcers or reinforcer parts situated on either side of the measuring line, that is to say that said layer has reinforcers or reinforcer parts axially on the inside of the measuring line and other reinforcers or reinforcer parts axially on the outside of the measuring line. Similarly, the radially outermost working layer at the shoulder is the working layer intersecting the measuring line and radially outermost.

The shoulder thickness of the tread is the distance along this measuring line between the radially outermost point of the tread on said line and the radially outermost point on the measuring line of the radially outermost crown layer at the shoulder. This radially outermost crown layer at the shoulder can either be the protective layer or the outermost working layer at the shoulder. The radially outermost point of the radially outermost crown layer at the shoulder is obtained by tracing a spline passing through the radially outermost points of each reinforcer of said layer; this spline intersects said measuring line through said point.

The shoulder thickness of the reinforcement is also measured on the meridian section, on said measuring line at the shoulder. The shoulder thickness of the reinforcement is the distance along this straight line between the radially outermost point of the radially outermost working layer at the shoulder and the radially innermost point of the radially innermost carcass layer. The measurement points belonging to the measuring line are obtained by the intersection of said line and of splines passing through the radially outermost points of the reinforcing elements of the radially outermost working layer at the shoulder and through the radially innermost points of the reinforcing elements of the radially innermost carcass layer, respectively.

Similarly, on this meridian section, the shoulder thickness of the carcass reinforcement is measured on the measuring line at the shoulder. The shoulder thickness of the carcass reinforcement is the distance between the radially outermost point of the radially outermost carcass layer and the radially innermost point of the radially innermost carcass layer. The measurement points belonging to the measuring line are obtained by the intersection of this line and of splines passing through the radially outermost points of the reinforcing elements of the radially outermost carcass layer and through the radially innermost points of the reinforcing elements of the radially innermost carcass layer, respectively.

For these same tires, the endurance of the crown means that, in the equatorial plane, the centre thickness of the tread is at most equal to 8.6 times the centre thickness of the carcass reinforcement. This is because a tread that is too thick entails a higher use temperature, resulting in a drop in the stiffness of the crown rubbers, it being possible for this to result in the cracking thereof during use of the tire.

According to a preferred embodiment, the shoulder thickness of the tread is at least equal to 1.2 times the shoulder thickness of the reinforcement. This balance between the thicknesses of the tread and of the reinforcement makes it possible to improve the balance between landing wear and rolling wear.

For these same tires, and for the same reasons, the crown endurance means that the shoulder thickness of the tread is a most equal to 3 times the shoulder thickness of the reinforcement.

Similarly, it is also advantageous, for good dimensioning in terms of rolling wear, for the shoulder thickness of the tread to be at least equal to 4.2 times the shoulder thickness of the carcass layer.

For these same tires, and for the same reasons, the crown endurance means that the shoulder thickness of the tread is a most equal to 8.6 times the shoulder thickness of the carcass layer.

It is particularly advantageous, in order to take up tensile forces in the working reinforcement, to dispose the reinforcing elements of the layers of this reinforcement in a manner parallel to one another and inclined at an angle of between +20° and −20° with respect to the circumferential direction (XX′).

According to a preferred embodiment, the carcass reinforcement comprises at least one carcass layer comprising mutually parallel reinforcing elements that form an angle of between 80° and 100° with the circumferential direction.

The invention is even more advantageous if the reinforcing elements of the working layers have a tenacity at least equal to 110 cN/tex.

In order to increase the tenacity of the working layers, it is particularly advantageous for the working layers to comprise reinforcing elements that consist of aromatic polyamides or a combination of aliphatic polyamides and aromatic polyamides. In other words, the material of which the reinforcing elements of the working layers are made is aramid. The reinforcing elements can consist of this single material or combine aramid and nylon to form reinforcing elements referred to as hybrid reinforcing elements. These hybrid reinforcing elements advantageously combine the extension properties of nylon and of aramid. These types of material are advantageously used in the field of aeroplane tires on account of their low density and their high rupture resistance, resulting in high tenacity. This high tenacity allows weight savings that are crucial in the aeronautical field, and notably a reduction in the number of working layers that are necessary for taking up forces compared with aeroplane tires of which the working and carcass reinforcements are made of nylon.

For these same advantages, in a preferred embodiment of the invention, the reinforcing elements of the carcass layers have a tenacity at least equal to 100 cN/tex.

Thus, it is particularly advantageous for the carcass layers to comprise reinforcing elements that consist of aromatic polyamides or a combination of aliphatic polyamides and aromatic polyamides.

Preferably, a protective reinforcement comprising at least one protective layer made up of metal or textile reinforcing elements is disposed radially on the outside of the working reinforcement in order to preserve the mechanical integrity of the working layers in the case that an obstacle is rolled over.

The features and other advantages of the invention will be understood better with the aid of FIGS. 1 to 4, said figures not being shown to scale but in a simplified manner so as to make it easier to understand the invention.

FIG. 1: crown of an aeroplane tire in a meridian plane and the thicknesses of the tread, of the working reinforcement, of the carcass reinforcement and of the reinforcement

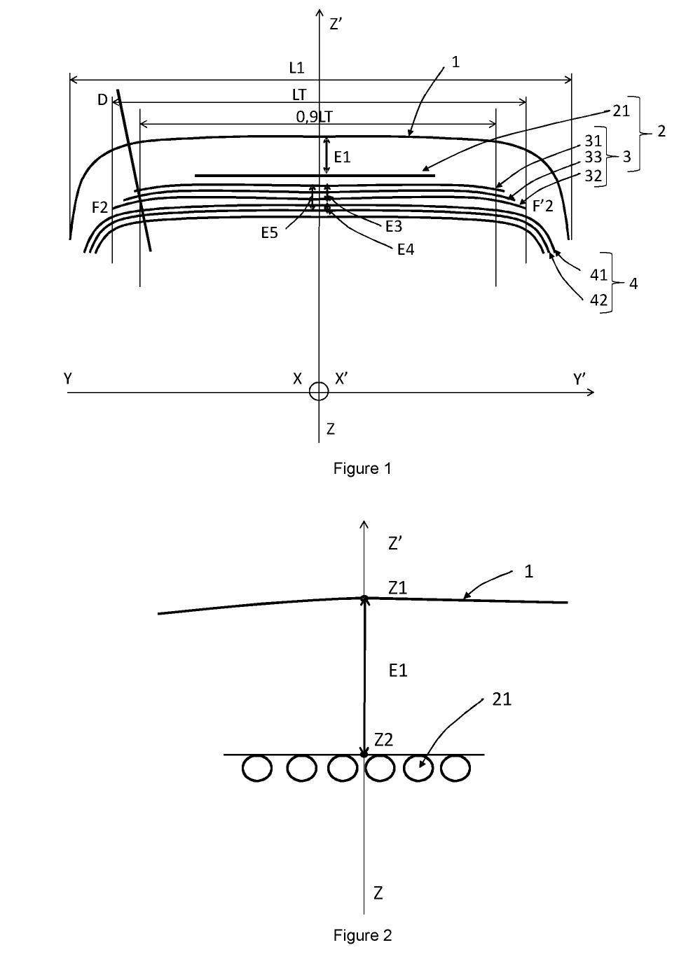

FIG. 2: measurement of the centre thickness of the tread in a meridian plane

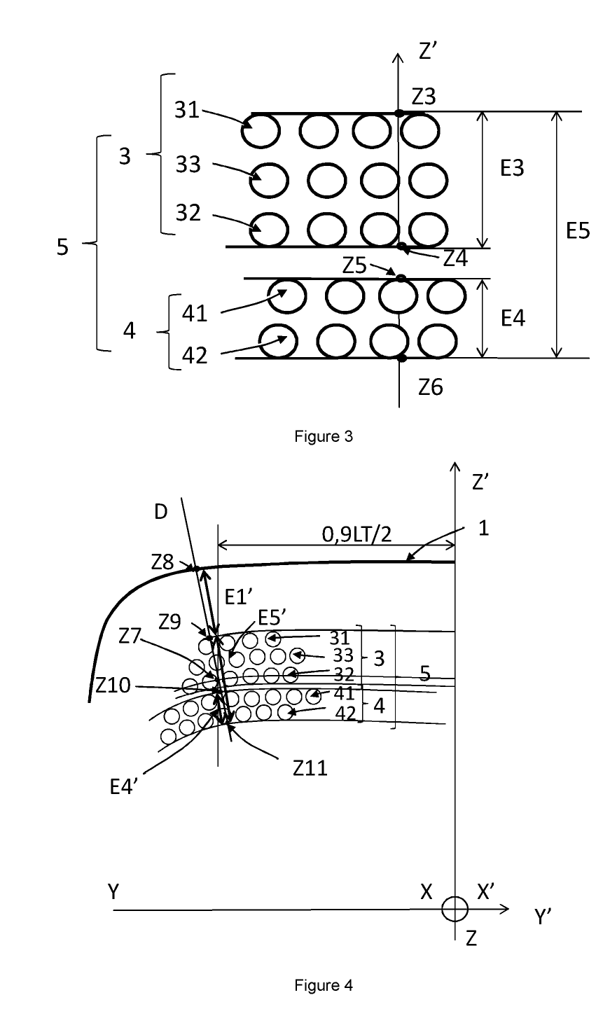

FIG. 3: measurement of the centre thicknesses of the working reinforcement and of the carcass reinforcement in a meridian plane

FIG. 4: measurement of the different shoulder thicknesses in a meridian plane

FIG. 1 shows a meridian section, i.e. a section in a meridian plane, of the crown of a tire according to one embodiment of the invention comprising a tread 1, a crown reinforcement 2 radially on the inside of the tread 1, comprising a protective layer 21 radially on the inside of the tread 1 and a working reinforcement 3 radially on the inside of the protective layer, a radial carcass reinforcement 4 radially on the inside of the working reinforcement 3. The reinforcement 5 consists of the carcass reinforcement 4 and the working reinforcement 3. The respective radial, axial and circumferential directions are the directions ZZ′, YY′ and XX′. The equatorial plane XZ is defined by the radial direction ZZ′ and the circumferential direction XX′. The figure also shows the position of the centre thickness E1 of the tread, the centre thickness E3 of the working reinforcement, the centre thickness E4 of the carcass reinforcement and the centre thickness E5 of the reinforcement.

The working reinforcement 3 is made up of several working layers. The axial width LT of the widest working layer 32 is the axial distance between its axial ends F2 and F′2 and is at least equal to two-thirds of the maximum axial width L1 of the tire. The maximum axial width L1 of the tire is measured at the sidewalls, with the tire mounted on its rim and lightly inflated, i.e. inflated to a pressure equal to 10% of the recommended nominal pressure.

FIG. 2 shows the principle of measuring the centre thickness E1 of the tread between the point Z1 defined as belonging to the equatorial plane XZ and being the radially outermost point of the tread and the point Z2 on the equatorial plane XZ that is determined by its intersection with the spline passing through the radially outermost points of the reinforcing elements of the radially outermost layer 21 of the crown reinforcement 2.

FIG. 3 shows the principle of measuring:

the centre thickness E5 of the reinforcement, between the points Z3 and Z6,
the centre thickness E3 of the working reinforcement, between the points Z3 and Z4,
the centre thickness E4 of the carcass reinforcement, between the points Z5 and Z6.

Z3 is defined as being the intersection of the equatorial plane XZ and the spline passing through the radially outermost points of the reinforcing elements of the radially outermost layer 31 of the working reinforcement 3. Z4 is defined as being the intersection of the equatorial plane XZ and the spline passing through the radially innermost points of the reinforcing elements of the radially innermost layer 32 of the working reinforcement 3. Z5 is defined as being the intersection of the equatorial plane XZ and the spline passing through the radially outermost points of the reinforcing elements of the radially outermost layer 41 of the carcass reinforcement 4. Z6 is defined as being the intersection of the equatorial plane XZ and the spline passing through the radially innermost points of the reinforcing elements of the radially innermost layer 42 of the carcass reinforcement 4.

FIG. 4 shows the principle of measuring the shoulder thickness E1′ of the tread, measured on the straight line D, the measuring line at the shoulder, passing through the centre of the tire and passing through the point Z7 of the widest working layer, said point Z7 being situated at an axial distance of 90% of its half-width LT/2. The radius from the centre of the closest reinforcing element will be taken as the precise radius of Z7. E1′ is measured between Z8 and Z9. Z8 is defined as being the radially outermost point of the tread belonging to D. Z9 is defined as being the point of intersection of D and the spline passing through the radially outermost points of the reinforcing elements of the radially outermost crown layer at the shoulder, in this case, the radially outermost crown layer at the shoulder is also the radially outermost working layer 31 at the shoulder.

FIG. 4 also shows the principle of measuring the shoulder thickness E5′ of the reinforcement measured on the straight line D. E5′ is measured between the point of intersection of D and the spline passing through the radially outermost points of the reinforcing elements of the radially outermost working layer 31 at the shoulder, in this case coincident with Z9, and Z11. Z11 is defined as being the point of intersection of D and the spline passing through the radially innermost points of the reinforcing elements of the radially innermost carcass layer 42.

FIG. 4 also shows the principle of measuring the shoulder thickness E4′ of the carcass reinforcement measured on the straight line D. E4′ is measured between Z10 and Z11. Z10 is defined as being the point of intersection of D and the spline passing through the radially outermost points of the reinforcing elements of the radially outermost carcass layer 41.

The inventors developed the invention, according to one embodiment, for an aeroplane tire of size 46×17R20, the use of which is characterized by a nominal pressure equal to 15.3 bar, a nominal static load equal to 20 473 daN, and a maximum reference speed of 360 km/h.

The reference tire and the tire produced in accordance with the invention have concave crowns within the meaning of the patent WO 2010000747.

The change from nylon working and carcass reinforcements to hybrid working and carcass reinforcements makes it possible to reduce the number of working layers from 10 to 7 and the number of carcass layers from 6 to 3, respectively.

The invention was carried out with a working reinforcement made up of 6 working layers, the reinforcing elements of which are of the hybrid type. The radially internal working layer has an axial width of 300 mm, i.e. 0.75 times the maximum axial width of the tire. The width of concavity of said radially internal working layer is 160 mm and the amplitude of concavity is 6 mm. The carcass reinforcement is made up of 3 carcass layers, the reinforcing elements of which are hybrid.

A hoop reinforcement is also used. The latter consists of a hooping layer, the reinforcing elements of which are of the hybrid type. For the working and hooping layers, the hybrid reinforcing elements used consist of two spun aramid yarns of 330 tex each and one spun nylon yarn of 188 tex. The diameter of the hybrid reinforcing element obtained is 1.11 mm, its count is 950 tex, its twist is 230 tpm, its elongation under 50 daN of force is 5.5% and its breaking force is 110 daN, i.e. a tenacity of 116 cN/tex.

For the carcass layers, the hybrid reinforcing elements used consist of two spun aramid yarns of 330 tex each and one spun nylon yarn of 188 tex. The diameter of the hybrid reinforcing element obtained is 1.1 mm, its count is 980 tex, its twist is 270 tpm, its elongation under 50 daN of force is 5.5% and its breaking force is 110 daN, i.e. a tenacity of 112 cN/tex. Further hybrid reinforcements could also be used. It is notably conceivable to use reinforcements with a different twist, or even reinforcements having a different count or a different number of each spun yarn.

The decrease in the maximum temperature on the equatorial plane makes it possible, while maintaining the endurance performance of the tire, to increase the centre thickness E1 of the tread from 16 mm to 18 mm, i.e. an increase in the thickness E1 of 12.5% and an increase in the volume of rubber to be used of 30%. A person skilled in the art will associate this increase in the thickness of the tread with an at least equivalent increase in the number of landings.

The decrease in the maximum temperature at the axial ends of the working layers makes it possible, while maintaining the endurance performance of the tire, to increase the shoulder thickness E1′ of the tread from 17.5 mm to 19.5 mm, i.e. an increase of 11%. A person skilled in the art will associate this increase in the thickness of the tread with an at least equivalent increase in the number of kilometres covered when taxiing.

In the reference tire, in the equatorial plane, the centre thickness E1 of the tread between the radially outer point of the tread and the radially outermost crown layer 21 is at most equal to 0.9 times the centre thickness E5 of the reinforcement between the radially outermost working layer 31 and the radially innermost crown layer 42, is at most equal to 1.2 times the centre thickness E3 of the working reinforcement between the radially outermost working layer 31 and the radially innermost working layer 32, and is at most equal to 3 times the centre thickness E4 of the carcass reinforcement E4 between the radially outermost carcass layer 41 and the radially innermost carcass layer 42.

In the tire according to the invention, in the equatorial plane, the centre thickness E1 of the tread is equal to 1.24 times the centre thickness E5 of the reinforcement, is equal to 1.64 times the centre thickness E3 of the working reinforcement, and is equal to 4.5 times the centre thickness E4 of the carcass reinforcement.

In the reference tire, at the shoulder, on the measuring line D, the shoulder thickness E1′ of the tread is at most equal to 1 time the shoulder thickness E5′ of the reinforcement between the radially outermost working layer and the radially innermost carcass layer, and is at most equal to 3 times the shoulder thickness E4′ of the carcass reinforcement between the radially outermost carcass layer and the radially innermost carcass layer.

In the tire according to the invention, on the straight line D, the shoulder thickness E1′ of the tread is equal to 1.26 times the shoulder thickness E5′ of the reinforcement and is equal to 4.88 times the shoulder thickness E4′ of the carcass reinforcement.

The estimate of the improvement in landing wear performance and rolling wear performance is at least 30% in correlation with the increase in the volume of rubber to be used.

1. Tire for an aeroplane, comprising:
a tread having a centre thickness that is measured in the equatorial plane, passing through the middle of the tread and perpendicular to the axis of rotation of the tire, between the radially outermost point of the tread and the radially outermost point of a crown reinforcement radially on the inside of the tread;
the crown reinforcement comprising at least one working reinforcement;
the working reinforcement comprising at least one working layer that has an axial width, measured over the working layer having the greatest axial width, at least equal to ⅔ of the maximum axial width of the tire, and having a centre thickness in the equatorial plane that is measured between the radially outermost point of the radially outermost working layer and the radially innermost point of the radially innermost working layer;
the working layers comprising textile reinforcing elements;
a carcass reinforcement, radially on the inside of the working reinforcement, comprising at least one carcass layer and having a centre thickness in the equatorial plane that is measured between the radially outermost point of the radially outermost carcass layer and the radially innermost point of the radially innermost carcass layer;
the carcass layers comprising textile reinforcing elements;
a reinforcement that is formed by the working reinforcement and the carcass reinforcement and has a centre thickness in the equatorial plane that is measured between the radially outermost point of the radially outermost working layer and the radially innermost point of the radially innermost carcass layer,
wherein the centre thickness of the tread is at least equal to 1.1 times the centre thickness of the reinforcement formed by the working reinforcement and the carcass reinforcement,
wherein the centre thickness of the tread is at least equal to 1.5 times the centre thickness of the working reinforcement, and
wherein the reinforcing elements of the working layers have a tenacity at least equal to 90 cN/tex.

2. The airplane tire according to claim 1, wherein the centre thickness of the tread is at least equal to 4.2 times the centre thickness of the carcass reinforcement, and wherein the reinforcing elements of the carcass layers have a tenacity at least equal to 90 cN/tex.

3. The airplane tire according to claim 1, a straight line that passes through the centre of the tire, at the intersection of the equatorial plane and the axis of rotation, and through the point of the widest working layer, said point being positioned at an axial distance from the equatorial plane equal to 0.9 times the axial half-width of said layer, being defined as the measuring line for the shoulder thicknesses, the tread having a shoulder thickness measured between the radially outermost point, positioned on the measuring line, of the tread and the radially outermost point, positioned on the measuring line, of the radially outermost crown layer, the reinforcement formed by the working reinforcement and the carcass reinforcement having a shoulder thickness between the radially outermost point, positioned on the measuring line, of the radially outermost crown layer, and the radially innermost point, positioned on the measuring line, of the radially innermost carcass layer, wherein the shoulder thickness of the tread is at least equal to 1.2 times the shoulder thickness of the reinforcement.

4. The airplane tire according to claim 1, the carcass reinforcement having a shoulder thickness, measured between the radially outermost point, positioned on the measuring line, of the radially outermost carcass layer and the radially innermost point, positioned on the measuring line, of the radially innermost carcass layer, wherein the shoulder thickness of the tread is at least equal to 4.2 times the shoulder thickness of the carcass reinforcement.

5. The airplane tire according to claim 1, wherein the working layers comprise mutually parallel reinforcing elements that form an angle of between +20° and −20° with the circumferential direction.

6. The airplane tire according to claim 1, wherein the carcass layers comprise mutually parallel reinforcing elements that form an angle of between 80° and 100° with the circumferential direction.

7. The airplane tire according to claim 1, wherein the reinforcing elements of the working layers have a tenacity at least equal to 110 cN/tex.

8. The tire according to claim 1, wherein the reinforcing elements of the working layers consist of aromatic polyamides or a combination of aliphatic polyamides and aromatic polyamides.

9. The airplane tire according to claim 1, wherein the reinforcing elements of the carcass layers have a tenacity at least equal to 110 cN/tex.

10. The airplane tire according to claim 1, wherein the reinforcing elements of the carcass layers consist of aromatic polyamides or a combination of aliphatic polyamides and aromatic polyamides.

11. The tire according to claim 1, wherein the crown reinforcement comprises at least one protective reinforcement radially on the inside of the tread and radially on the outside of the working reinforcement which comprises at least one protective layer that comprises metal or textile reinforcing elements.
